(19) United States
(12) Patent Application Publication
(10) Pub. No.: US 2020/0011368 A1
(43) Pub. Date: Jan. 9, 2020

(54) NUT CAP

(71) Applicant: Novaria Holdings, LLC, North Richland Hills, TX (US)

(72) Inventor: Jimmy Wayne Mahaffey, Ravenden, AR (US)

(73) Assignee: Novaria Holdings, LLC, North Richland Hills, TX (US)

(21) Appl. No.: 16/503,359

(22) Filed: Jul. 3, 2019

Related U.S. Application Data
(60) Provisional application No. 62/695,644, filed on Jul. 9, 2018.

(51) Int. Cl. F16B 37/14

(52) U.S. Cl. CPC F16B 37/14; F16B 43/001

(57) ABSTRACT

A fastening system is disclosed. The fastening system may have a washer and a cap. The cap may attach to the washer to protect a bolt and/or a nut disposed at least partially inside a cavity of the cap.

### CROSS-REFERENCE TO RELATED APPLICATIONS

This application claims the benefit of and priority to co-pending U.S. Prov. Pat. App. No. 62/695,644, filed on Jul. 9, 2018, and entitled “NUT CAP,” the disclosure of which is hereby incorporated by reference in its entirety.

### FIELD

The present disclosure relates generally to fasteners, and more specifically, to a cap to cover a nut and/or bolt.

### BACKGROUND

Frequently fasteners are used to join articles together. One such fastener may be a nut tightened along a bolt. Frequently the nut and/or protruding end of the bolt may be exposed to harsh elements, for instance moisture, chemicals, salt, etc. Moreover, the nut and/or protruding end of the bolt may contact proximate articles, such as wires passing nearby. In various instances, the exposure to harsh elements may wear, corrode, and/or rust the nut and/or bolt, causing weakness and/or difficulty loosening and/or fastening. Furthermore, nut and/or protruding end of the bolt may be desired to be electrically insulated from proximate articles. Yet also, contact between the nut and/or protruding end of the bolt and proximate articles may cause proximate articles, such as wires, to fray due to contact.

### SUMMARY

A washer is provided. The washer may include a main washer body and an edge ring. The main washer body may include a plate defining an encircled aperture and extending radially outward to an outward edge. The edge ring may include a raised flange disposed about the outward edge of the washer. The raised flange may have an outward threaded face. In various embodiments, the outward threaded face is a face of the edge ring and has threads configured to receive corresponding threads of an inner threaded face of a cap.

In various embodiments, the plate is annular. In various embodiments, the face of the edge ring associated with the outward threaded face is a radially outermost face of the edge ring relative to the central longitudinal axis. In various embodiments, the encircled aperture is defined through a center of the main washer body.

The main washer body may further define a washer counterbore having a cavity disposed in the plate and configured to receive at least a portion of a nut therein. The washer counterbore may have a floor and a lip, the floor bounded by the lip, the lip encircling the floor and extending away from the floor, the lip being a cylindrical wall joined along one edge to the floor and defining a seat into which a nut may rest against the floor. The raised flange may be cylindrical and disposed circumferentially about the outward edge of the washer. The raised flange may extend in a direction of a normal axis of the main washer body. The raised flange may be integrally formed of a same piece of material with the main washer body. Moreover, the washer may be threadably joinable to the cap and at least partially received into the cap.

In various embodiments, a cap is provided. The cap may include a primary member and an inner threaded face. The primary member may include a wall member and a floor member defining a cylinder with an open end. The inner threaded face may be a radially inward face of the wall member configured to receive the threads of an outward threaded face of a washer.

The cap may also have a contact edge including an edge of the wall member of the primary member positioned opposite the floor member and configured to contact an article being joined by a combination of a nut and a bolt, wherein the cap at least partially encloses the nut. The contact edge may include an edge channel, the edge channel being an annular groove defined in a face of the contact edge and forming a channel. The channel may receive an O-ring at least partially therein.

In various embodiments, a method of using a fastening system having a washer and a cap is provided. The method may include positioning a washer annularly encircling at least a portion of a bolt, threading a nut onto the bolt and tightening the nut against the washer, and threading a cap onto an edge ring of the washer. The edge ring may be an outward threaded face of the washer corresponding to an inner threaded face of the cap, and the cap may be affixed over at least one of the nut and the bolt to ameliorate environmental exposure thereof.

In various embodiments of the method, the mentioned washer may include a main washer body and an edge ring. The main washer body may include an plate defining an encircled aperture and extending radially outward to an outward edge. The edge ring may include a raised flange disposed about the outward edge of the washer and having the outward threaded face. The outward threaded face may include a face of the edge ring and includes threads configured to receive corresponding threads of the inner threaded face of a cap.

In various embodiments of the method, the cap may include a primary member and an inner threaded face. The primary member may include a wall member and a floor member defining a cylinder with an open end. the inner threaded face ay include a radially inward face of the wall member configured to receive the threads of the outward threaded face of the washer.

The mentioned washer may, in various embodiments of the method, include wherein the plate is annular. Moreover, the face of the edge ring of the outward threaded face may be a radially outermost face of the edge ring relative to the central longitudinal axis. The encircled aperture may be defined through a center of the main washer body. Finally, the main washer body may further define a washer counterbore including a cavity disposed in the plate and configured to receive at least a portion of the nut therein.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates an isometric view of an example fastening system including a bolt, nut, washer, and cap, in accordance with various embodiments;

FIG. 2 illustrates a section view of an example fastening system including a bolt, nut, washer, and cap, in accordance with various embodiments;

FIG. 3 illustrates different example fastening systems of different sizes, in accordance with various embodiments;

FIG. 4 illustrates an example washer, in accordance with various embodiments;

FIG. 5 illustrates an example cap, in accordance with various embodiments;

FIG. 6 illustrates an isometric view of an example washer attached to an example cap, in accordance with various embodiments;

FIG. 7 illustrates a section view of an example washer attached to an example cap, in accordance with various embodiments; and

FIG. 8 illustrates an example method of using a fastening system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

To be oriented “outward” of an object means having a position farther from a shared reference point than the object. For example, to be outward of a longitudinal axis relative to an object means having a distance from the longitudinal axis, a lateral vector component of which is greater than that of a corresponding lateral vector component of the distance of the object from the shared longitudinal axis.

Similarly, as used herein a “direction” and an “opposing direction” comprise directions having a vector component extending at least partially in opposite directions, such as wherein the statement pointing in a “first direction” means having a vector component extending at least partially opposite an “opposing second direction.”

Finally, as used herein “forward” and “aft” may describe relative positions along a longitudinal axis relative to another object. As used herein, forward means toward to an extreme distal end of a threaded portion of the bolt, whereas aft means the opposite of forward. For example, a nut is typically forward of a washer when attached to a bolt, whereas a washer is typically aft of a nut when attached to a bolt.

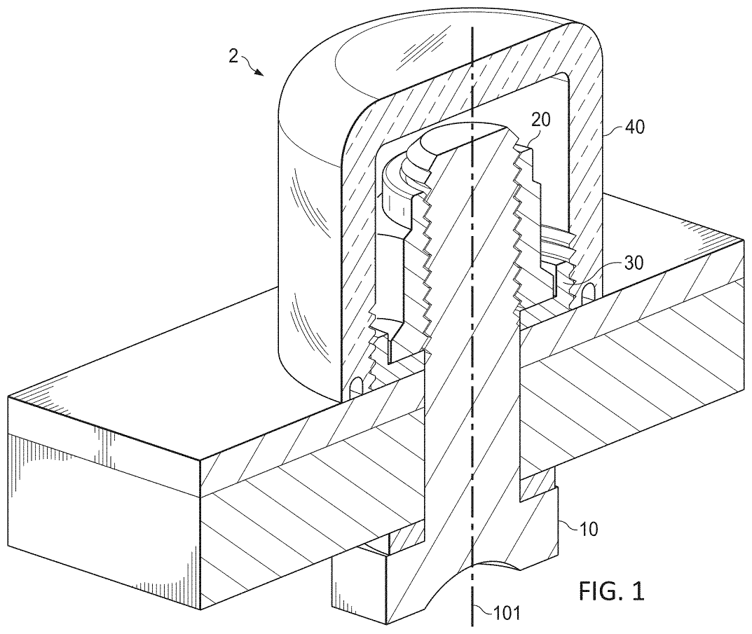

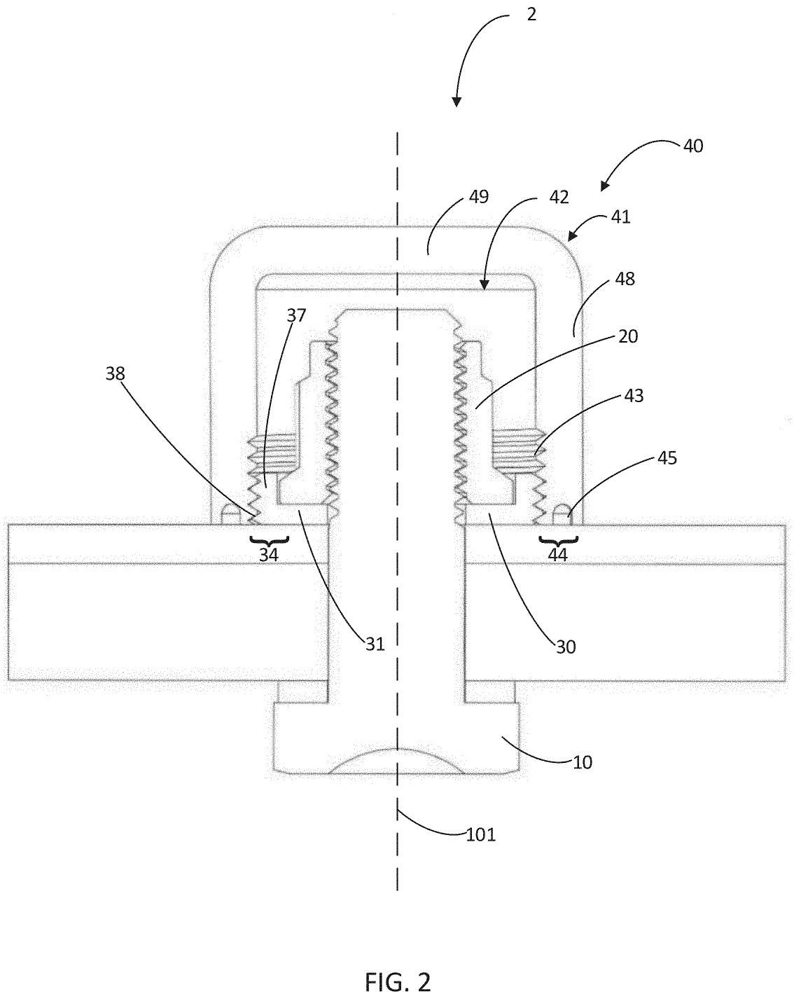

With reference to FIGS. 1 and 2, a fastening system 2 is provided. The fastening system 2 comprises a combination of fastening elements configured to join at least two articles together. The fastening system 2 may include a bolt 10 and a nut 20 that can thread onto a threaded portion of the bolt 10, sandwiching articles to be joined along the length of the bolt 10.

The fastening system 2 may include a washer 30. The washer 30 may be placed between the nut 20 and an article being loaded in compression by the combination of bolt 10 and nut 20. The washer 30 may increase the contact area of the nut 20 in conjunction with the article. The fastening system 2 may also include a cap 40. The cap 40 may comprise a protective aspect. For instance, the cap 40 may define a cavity sized to receive at least a portion of a nut 20 and or bolt 10 and may be joinable to the washer 30. For instance, the cap 40 may be closed on all but one size, and the one open side may be threadably connectable to the washer 30, wherein an internal cavity of the cap 40 is closed. The fastening system 2 may have a washer 30 attachable to a cap 40 configured to enclose at least a portion of a nut 20 and/or bolt 10.

A shared central longitudinal axis 101 may align with a center of an aperture of the nut 20 and/or the central axis of the bolt 10, and/or a center of an aperture of the washer 30, and may extend longitudinally through the center of the bolt 10, nut 20, washer 30, and cap 40.

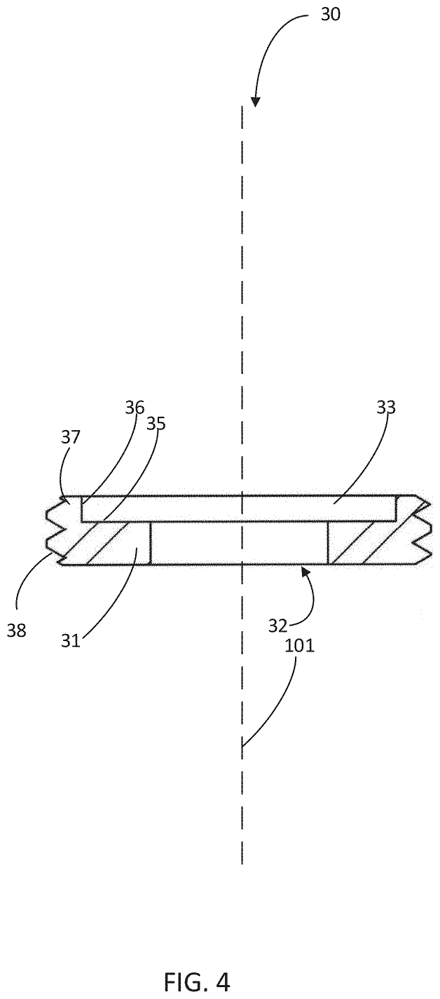

Turning now to FIGS. 2 and 4, specific aspects of the washer 30 are now introduced. A washer 30 may comprise an annular member compressible between a nut 20 and an object joined in compressive loading to the combination of nut 20 and bolt 10. The washer 30 may be an annulus, or in further embodiments, may have different shapes as desired.

Washer 30 may include a main washer body 31. A main washer body 31 comprises a primary flange of the washer 30. The main washer body 31 may comprise an annular plate, for instance, resembling a flat donut, though further shapes may be contemplated. A bolt channel 32 may comprise an aperture defined through the main washer body 31. In various instances, the bolt channel 32 is aligned centered on a central longitudinal axis 101 during use, the central longitudinal axis 101 extending normal to the main washer body 31 through a center of the bolt channel 32. Thus one may say that the main washer body 31 comprises an annular plate defining an encircled aperture (bolt channel 32) and extending radially outward to an outward edge (e.g., extending to edge ring 34).

Washer 30 may include a washer counterbore 33. A washer counterbore 33 may include a cavity disposed in the washer 30 and configured to receive at least a portion of the nut 20 therein. For instance, the washer counterbore 33 may include a floor 35 and a lip 36. The floor 35 may comprise a face contactable to the nut 20 and configured for compressive loading by the nut 20. The lip 36 may extend away from the floor 35, forming a cylindrical wall joined along one edge to the floor 35. The lip 36 and floor 35 may define a seat into which nut 20 may nest. In various embodiments the lip 36 extends forward of the floor according to the definition of forward introduced herein.

Washer 30 may include an edge ring 34. Edge ring 34 may be an outer edge of the washer 30 configured to selectably mechanically connect to the cap 40. For instance, the edge ring 34 may comprise a threaded aspect, such as an outward threaded face 38, threadably connectable to the cap 40.

The edge ring 34 may comprise a raised circumferential flange 37. The raised circumferential flange 37 may be cylindrical and may be circumferentially about the outward edge of the washer. Thus the edge ring 34 may extend forwardly away from the main washer body 31. For instance, a main washer body 31 may lie in a plane normal to the central longitudinal axis 101. The edge ring 34 may comprise a cylinder section that may extend along the longitudinal axis forward of the outer edge of the washer 30. Stated differently, the raised circumferential flange 37 may encircle the central longitudinal axis 101 and extend in the direction of a normal axis of the main washer body 31. In various instances, the circumferential flange 37 is integrally formed of a same piece of material with the main washer body 31.

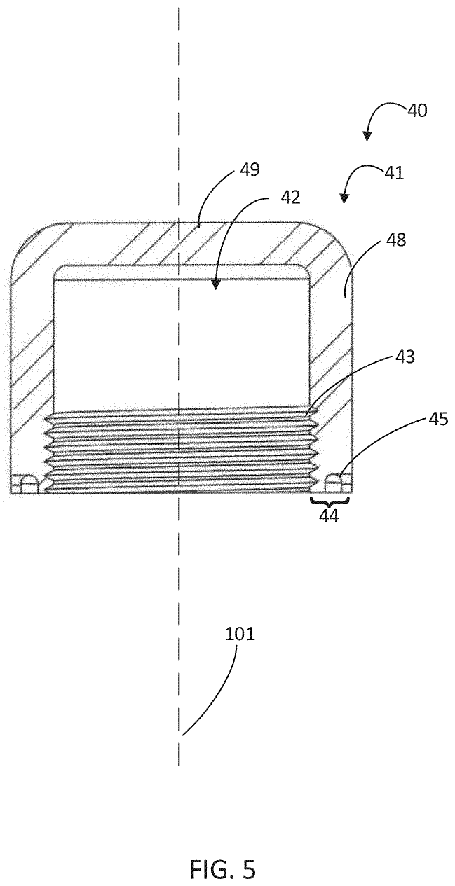

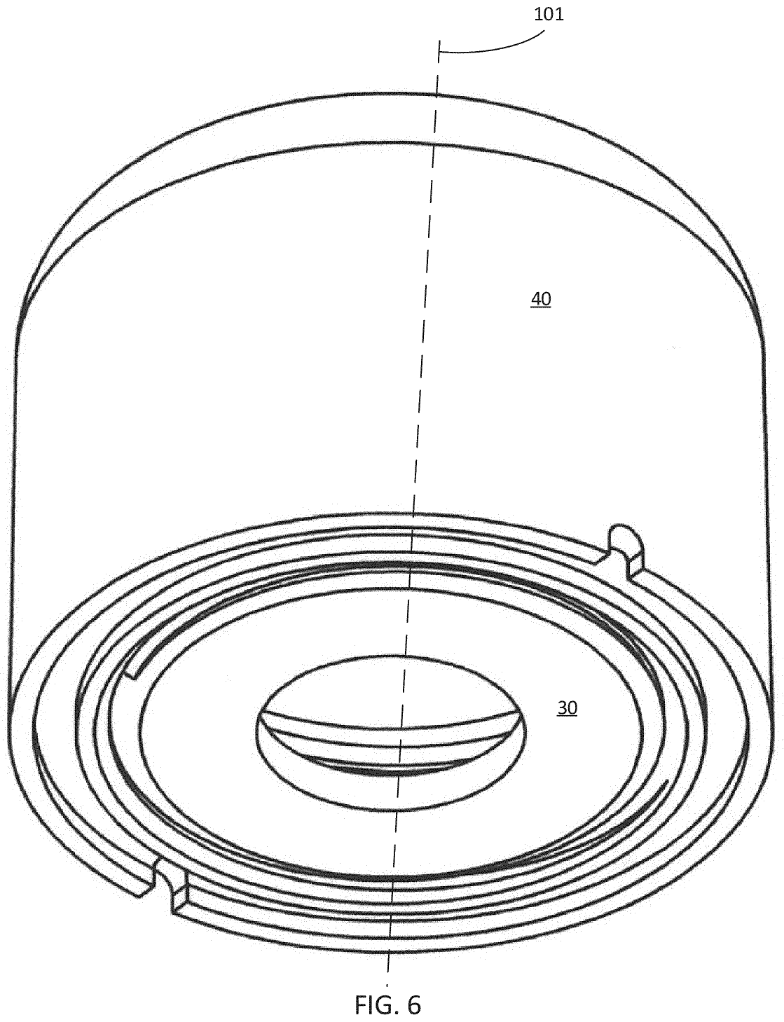

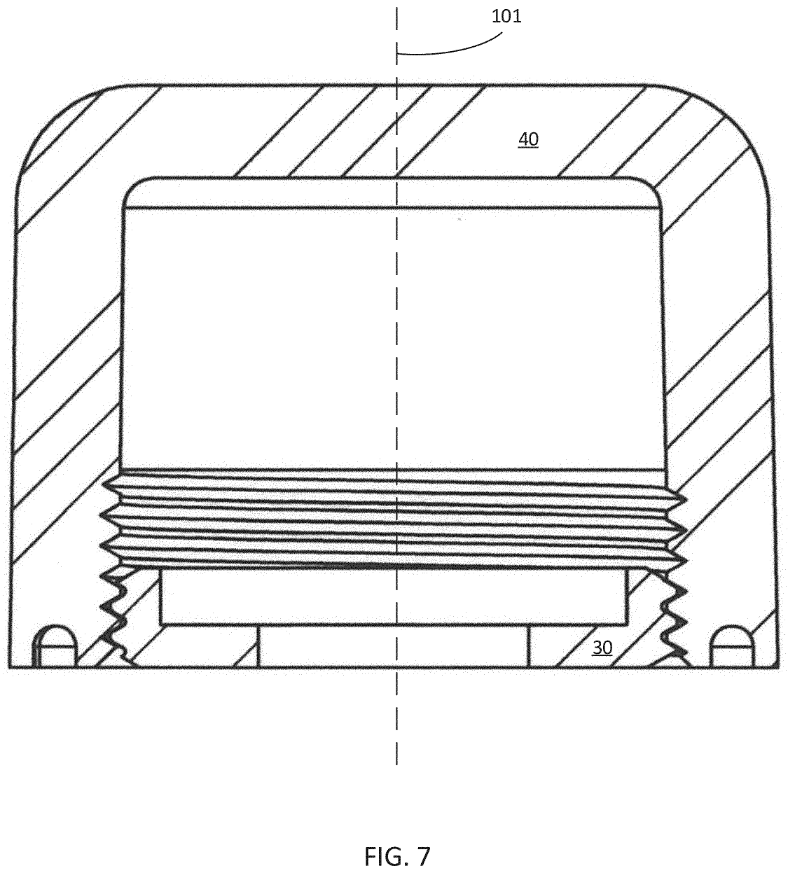

The edge ring 34 may comprise an outward threaded face 38. The outward threaded face 38 may be a radially outermost face of the edge ring 34 relative to the central longitudinal axis 101. The outward threaded face 38 may comprise outward facing threads extending outwardly from the edge ring 34 relative to the central longitudinal axis 101. In various embodiments, the outward threaded face 38 comprises threads structured to receive corresponding threads of an inner threaded face 43 of a cap 40 (See FIGS. 2, 5-7). In this manner, and with momentary reference to FIGS. 6 and 7, a washer 30 may be threadably joined to a cap 40 and may be received at least partially into the cap 40.

With renewed reference to FIGS. 1, 2, and 4, in further instances, the edge ring 34 comprises a localized thickening of the main washer body 31. Thus, while depicted as a cylindrical flange disposed circumferentially about the outward edge of the washer 30, in further instances, the edge ring 34 may extend from a face of the main washer body 31 (rather than an edge of the main washer body 31).

Thus, it may be said that a washer 30 may comprise an annular main washer body 31 and a cylindrical edge ring 34 comprising a circumferential flange 37 extending longitudinally from an outward edge of the main washer body 31.

Shifting focus to the combination of FIG. 1 and FIGS. 2, and 5, the cap 40 is now discussed in further detail. A cap 40 comprises a covering member open on one face to connect to the washer 30 and otherwise closed to protect at least a portion of the washer 30, a nut 20, and a bolt 10. For instance, a cap 40 may be attached to a washer 30 so that a portion of the bolt 10 and a nut 20 are inside a cavity of the cap 40 and the washer 30 closes the cavity.

A cap 40 may comprise a primary member 41. A primary member 41 may comprise a main body of the cap 40. In various embodiments, a primary member 41 comprises a cylinder with an open end. In further embodiments, a primary member 41 comprises any other shape as desired. As shown herein, a primary member 41 may comprise a wall member 48 and a floor member 49. The wall member 48 may comprise a cylindrical flange, and a floor member 49 may comprise a closure of one end of the cylindrical flange. In this manner, a cylinder with an open end may be formed.

A cap 40 may define an inner cavity 42. An inner cavity 42 may comprise a space defined by the wall member 48 and the floor member 49 and configured to receive a portion of a bolt 10 and a nut 20 and to be enclosed at an open end by the washer 30.

A cap 40 may include an inner threaded face 43. The inner threaded face 43 may comprise a radially inwardly facing threaded surface of the wall member 48 of the cap 40 configured to receive the threads of the outward threaded face 38 of the washer 30. For instance, the inner threaded face 43 of the cap 40 may comprise an inward surface of the primary member 41. More specifically, the inner threaded face 43 of the cap 40 may comprise an inward surface of the wall member 48 of the cap 40. The inner threaded face 43 of the cap 40 may comprise an inward surface of the wall member 48 of the cap 40 positioned opposite the floor member 49 along a central longitudinal axis 101 and configured to receive corresponding threads of an outward threaded face 38 of the edge ring 34 of the washer 30.

A cap 40 may include a contact edge 44. A contact edge 44 may comprise an edge of the primary member 41, and specifically, an edge of the wall member 48 opposite the floor member 49 and configured to contact an article being joined by the bolt 10, nut 20, and washer 30. For instance, as the cap 40 threadably joins to the washer 30, the contact edge 44 may contact an article being joined by the bolt 10, nut 20, and washer 30 and may exert an interference fit, pressing against the article. In various embodiments, the contact edge 44 comprise an edge of the primary member 41 lying in a normal plane of the central longitudinal axis 101 and comprising a distal most edge of wall member 48 of the primary member 41, opposite the floor member 49.

In various embodiments, the contact edge 44 comprises an edge channel 45. An edge channel 45 may comprise an annular groove defined in a face of the contact edge 44, forming a channel. In various embodiments, the edge channel 45 facilitates flexure of the contact edge 44, facilitating compressive loading to ameliorate unscrewing of the cap 40. In further instances, the edge channel 45 is configured to receive a compressible O-ring, for example, to effectuate a fluid seal of the inner cavity 42 and ameliorate fluid ingress and subsequent corrosion and/or rust of the bolt 10, nut 20, and/or washer 30.

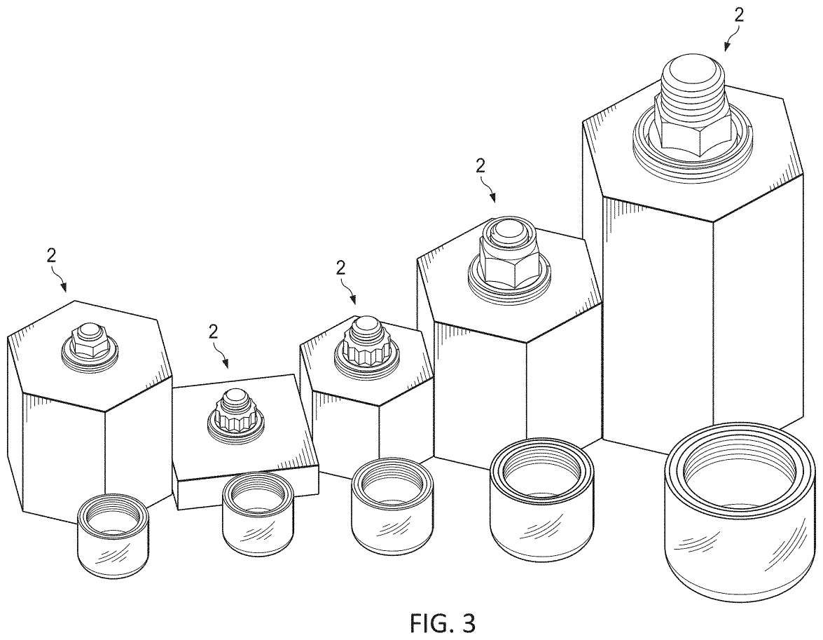

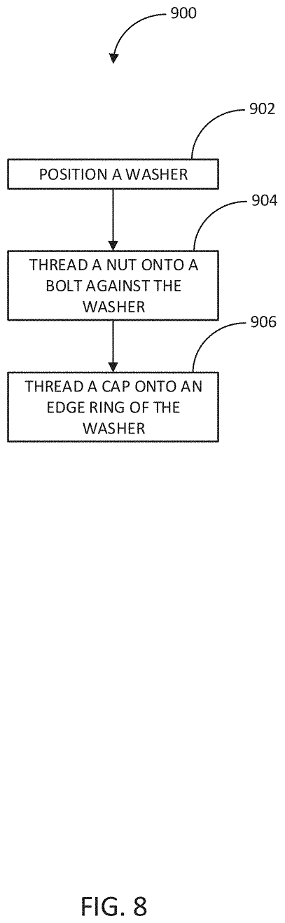

With reference to FIGS. 1-7 but with particular emphasis on FIG. 8, a method 900 of using a fastening system 2 is provided. In various embodiments, a washer 30 may be positioned annularly encircling at least a portion of a bolt 10 (block 902). A nut 20 may be threaded onto the bolt 10 and tightened against the washer 30 (block 904). A cap 40 may be threaded onto an edge ring 34 of the washer 30, the edge ring 34 comprising an outward threaded face 38 corresponding to an inner threaded face 43 of a wall member 48 of a primary member 41 of the cap 40 (block 906). In this manner, the cap 40 may be affixed over at least one of the nut 20 and the bolt 10 and may ameliorate environmental exposure thereof.

With reference to FIGS. 1-8, having discussed aspects of a fastening system 2, a fastening system 2, and/or its component washer 30 and/or cap 40 may be made of various materials. For instance, a fastening system 2, and/or its component washer 30 and/or cap 40 may be made of a single material, or different materials, or combinations of materials. For example, components of the system are made from metal. For example, aspects of a fastening system 2, and/or its component washer 30 and/or cap 40 are metal, such as nickel, cobalt, molybdenum, titanium, aluminum, steel, or stainless steel, though it alternatively comprises numerous other materials configured to provide support. Components of the system are optionally made from other materials such as, for example, composite, ceramic, plastics, polymers, alloys, glass, binder, epoxy, polyester, acrylic, or any material or combination of materials having desired material properties, such as heat tolerance, strength, stiffness, or weight. In various instances the cap 40 is transparent.

Portions of a fastening system 2, and/or its component washer 30 and/or cap 40 as disclosed herein are optionally made of different materials or combinations of materials, and/or comprise coatings. Moreover, components of the fastening system 2, and/or its component washer 30 and/or cap 40 are in some instances mixtures of different materials according to different ratios, gradients, and the like.

A fastening system 2, and/or its component washer 30 and/or cap 40 thus may have multiple materials, or any material configuration suitable to enhance or reinforce the resiliency and/or support of the system when subjected to wear in an operating environment such as an aircraft operating environment, or to satisfy other desired electromagnetic, chemical, physical, or material properties, for example coefficient of thermal expansion, ductility, weight, flexibility, strength, or heat tolerance.

One such material is Trogamid. In various embodiments, a fastening system 2, and/or its component washer 30 and/or cap 40 may comprise Trogamid, such as Trogamid CX7323 polyamide. In various embodiments, a fastening system 2, and/or its component washer 30 and/or cap 40 may comprise cadmium plate. The fastening system 2, and/or its component washer 30 and/or cap 40 may be passivated.

Further such material may be an austenitic nickel-chromium-based alloy such as Inconel®, which is available from Special Metals Corporation of New Hartford, N.Y., USA. Other such material includes ceramic matrix composite (CMC). Further material includes refractory metal, for example, an alloy of titanium, such as, titanium-zirconium-molybdenum (TZM).

Various benefits and advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A washer comprising:
a main washer body comprising a plate defining an encircled aperture and extending radially outward to an outward edge;
an edge ring disposed about the outward edge of the washer and comprising an outward threaded face;
wherein the outward threaded face comprises a face of the edge ring and comprises threads configured to receive corresponding threads of an inner threaded face of a cap.

2. The washer according to claim 1, wherein the plate is annular and the edge ring comprises a raised flange disposed about the outward edge of the plate of the washer.

3. The washer according to claim 1, wherein the face of the edge ring comprised of the outward threaded face is a radially outermost face of the edge ring relative to the central longitudinal axis.

4. The washer according to claim 1, wherein the encircled aperture is defined through a center of the main washer body.

5. The washer according to claim 1, wherein the main washer body further defines a washer counterbore comprising a cavity disposed in the plate and configured to receive at least a portion of a nut therein.

6. The washer according to claim 5, wherein the washer counterbore comprises a floor and a lip, the floor bounded by the lip, the lip encircling the floor and extending away from the floor, the lip comprising a cylindrical wall joined along one edge to the floor and defining a seat into which a nut may rest against the floor.

7. The washer according to claim 1, wherein the edge ring comprises a raised flange that is cylindrical and is disposed circumferentially about the outward edge of the washer.

8. The washer according to claim 7, wherein the raised flange extends in a direction of a normal axis of the main washer body.

9. The washer according to claim 8, wherein the raised flange is integrally formed of a same piece of material with the main washer body.

10. The washer according to claim 1, wherein the washer is threadably joinable to the cap and at least partially received into the cap.

11. A cap comprising:
a primary member comprising a wall member and a floor member defining a partial enclosure with an open end; and
an inner threaded face comprising a radially inward face of the wall member configured to receive the threads of an outward threaded face of a washer.

12. The cap according to claim 11, further comprising a contact edge comprising an edge of the wall member of the primary member positioned opposite the floor member and configured to contact an article being joined by a combination of a nut and a bolt, wherein the cap at least partially encloses the nut
wherein the contact edge comprises an edge channel, the edge channel comprising an annular groove defined in a face of the contact edge and forming a channe.

13. The cap according to claim 11, wherein the partial enclosure is at least one of (i) at least partially conic and (ii) at least partially cylindrical.

14. A method of using a fastening system comprising a washer and a cap, the method comprising:
positioning a washer annularly encircling at least a portion of a bolt;
threading a nut onto the bolt and tightening the nut against the washer; and
threading a cap onto an edge ring of the washer, the edge ring comprising an outward threaded face of the washer corresponding to an inner threaded face of the cap,
wherein the cap is affixed over at least one of the nut and the bolt to ameliorate environmental exposure thereof.

15. The method according to claim 14, wherein the washer comprises:
a main washer body comprising an plate defining an encircled aperture and extending radially outward to an outward edge;
the edge ring disposed about the outward edge of the washer and comprising the outward threaded face;
wherein the outward threaded face comprises a face of the edge ring and comprises threads configured to receive corresponding threads of the inner threaded face of a cap.

16. The method according to claim 15, wherein the cap comprises:
a primary member comprising a wall member and a floor member defining a partial enclosure with an open end; and
an inner threaded face comprising a radially inward face of the wall member configured to receive the threads of the outward threaded face of the washer.

17. The method according to claim 15, wherein the plate is annular and the edge ring comprises a raised flange disposed about the outward edge of the plate of the washer.

18. The method according to claim 17, wherein the face of the edge ring comprised of the outward threaded face is a radially outermost face of the edge ring relative to the central longitudinal axis.

19. The washer according to claim 18, wherein the encircled aperture is defined through a center of the main washer body.

20. The washer according to claim 19, wherein the main washer body further defines a washer counterbore comprising a cavity disposed in the plate and configured to receive at least a portion of the nut therein
